(19) United States
(12) Patent Application Publication
(10) Pub. No.: US 2012/0174140 A1
(43) Pub. Date: Jul. 5, 2012

(54) DISK CHUCKING DEVICE

(75) Inventors: Young Sun YOO, Suwon (KR); Kyung Su PARK, Suwon (KR); Pyo KIM, Suwon (KR)

(73) Assignee: SAMSUNG ELECTRO-MECHANICS CO., LTD.

(21) Appl. No.: 13/044,094

(22) Filed: Mar. 9, 2011

(30) Foreign Application Priority Data
Dec. 29, 2010 (KR) 10-2010-0138335

(51) Int. Cl. G11B 17/028

(52) U.S. Cl. 720/707; G9B/17.006

(57) ABSTRACT

There is provided a disk chucking device including: a chucking mechanism body installed on a rotor case; a chuck chip movably installed on the chucking mechanism body and fixing a disk thereto; and a spring member installed such that both ends thereof are supported by the chucking mechanism body and the chuck chip, and including a permanent deformation suppressing part provided in a bent portion thereof in order to prevent permanent deformation of the bent portion when the disk is loaded and unloaded and having a smaller pitch than that of other portions.

### CROSS-REFERENCE TO RELATED APPLICATIONS

This application claims the priority of Korean Patent Application No. 10-2010-0138335 filed on Dec. 29, 2010, in the Korean Intellectual Property Office, the disclosure of which is incorporated herein by reference.

### BACKGROUND OF THE INVENTION

1. Field of the Invention

The present invention relates to a disk chucking device, and more particularly, to a disk chucking device installed on a spindle motor and having a disk rotatably loaded thereon.

2. Description of the Related Art

Generally, a spindle motor installed in an optical disk drive serves to rotate a disk so that an optical pickup mechanism can read data recorded on the disk.

Meanwhile, the spindle motor includes a disk chucking device securing a disk loaded thereon, and the disk loaded on the disk chucking device is rotated by the spindle motor. Meanwhile, in order to remove the disk from the optical disk drive, the disk is unloaded from the disk chucking device.

Meanwhile, the disk chucking device includes an elastic member for loading or unloading the disk, and may have the disk loaded thereon by the elastic force of the elastic member.

However, in the case in which the reliability of the elastic member is not secured, damage to the elastic member may be generated due to the repetitive loading and unloading of the disk. In this case, various vibrations and noise may be caused.

That is, damage to the elastic member is generated in a portion in which the elastic member is deformed by being bent upwardly and downwardly due to the repetitive loading or unloading of the disk, thereby causing various vibrations and noise.

In addition, in the case in which the elastic member is damaged, the loading or unloading of the disk may not be smoothly performed, such that the disk may idle during the driving of the spindle motor, thereby causing a problem in which the disk is not rotated at normal speed.

### SUMMARY OF THE INVENTION

An aspect of the present invention provides a disk chucking device allowing for a reduction in vibrations and noise generated during the rotations of a disk.

According to an aspect of the present invention, there is provided a disk chucking device including: a chucking mechanism body installed on a rotor case; a chuck chip movably installed on the chucking mechanism body and fixing a disk thereto; and a spring member installed such that both ends thereof are supported by the chucking mechanism body and the chuck chip, and including a permanent deformation suppressing part provided in a bent portion thereof in order to prevent permanent deformation of the bent portion when the disk is loaded and unloaded, and having a smaller pitch than that of other portions.

The permanent deformation suppressing part maybe wound to have turns in a range of 1.5 to 5.

The chucking mechanism body may include an opening allowing the chuck chip to be exposed outwardly.

The chucking mechanism body may include a chuck chip supporting part disposed under the opening in order to guide the chuck chip by contacting an outer surface of the chuck chip during movement of the chuck chip.

A guiding surface of the chuck chip supporting part may be in contact with a contact surface of the chuck chip and has a shape corresponding to that of the contact surface of the chuck chip in order to guide the chuck chip.

The chucking mechanism body may include a coupling protrusion inserted into an inside of one end of the spring member and preventing separation of the spring member.

The chuck chip may include an insertion protrusion inserted into an inside of the other end of the spring member and preventing separation of the spring member.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a cross-sectional view schematically showing a spindle motor having a disk chucking device according to an exemplary embodiment of the present invention installed thereon;

FIG. 2 is a partially enlarged view of a disk chucking device according to an exemplary embodiment of the present invention; and

FIGS. 3 through 5 illustrate the operations of a disk chucking device according to an exemplary embodiment of the present invention.

### DETAILED DESCRIPTION OF THE PREFERRED EMBODIMENT

Exemplary embodiments of the present invention will now be described in detail with reference to the accompanying drawings. However, it should be noted that the spirit of the present invention is not limited to the embodiments set forth herein and those skilled in the art and understanding the present invention could easily accomplish retrogressive inventions or other embodiments included in the spirit of the present invention by the addition, modification, and removal of components within the same spirit, but those are to be construed as being included in the spirit of the present invention.

Further, when it is determined that the detailed description of the known art related to the present invention may obscure the gist of the present invention, the detailed description thereof will be omitted.

After a motor having a disk chucking device installed thereon is schematically described, a disk chucking device according to an exemplary embodiment of the present invention will be described.

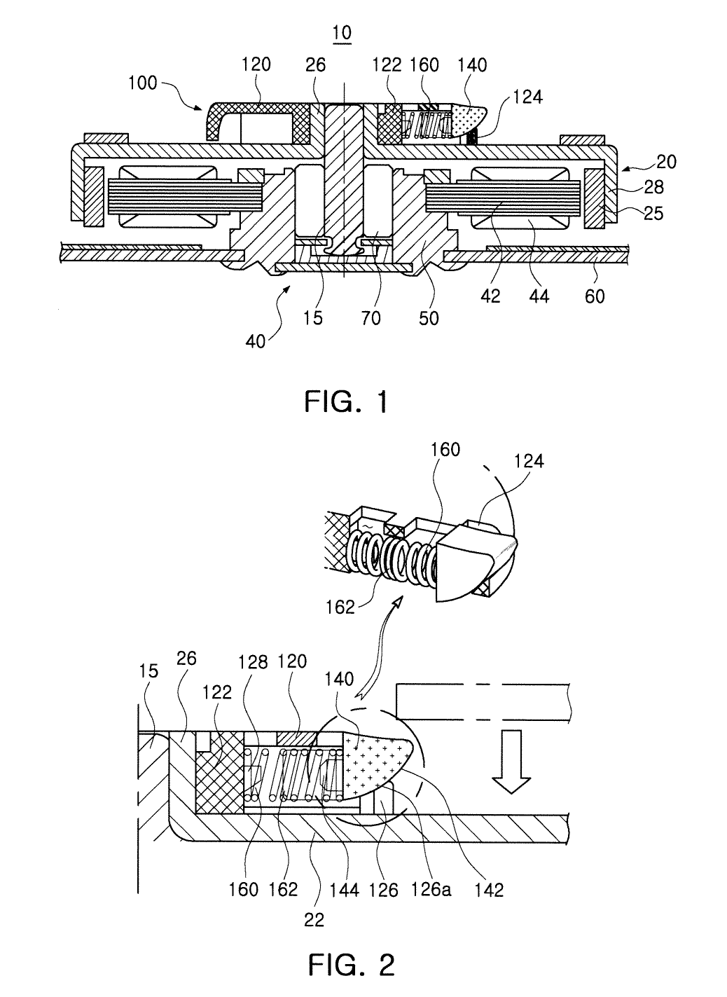

FIG. 1 is a cross-sectional view schematically showing a spindle motor having a disk chucking device according to an exemplary embodiment of the present invention installed thereon.

Referring to FIG. 1, a motor 10 is a spindle motor applied to an optical disk drive rotating a disk and includes a rotor 20 and a stator 40.

The rotor 20 includes a cup-shaped rotor case 22 which has a magnet 25 having an annular shape corresponding to a stator core 42 along an inner circumference thereof. The magnet 25 is a permanent magnet that has north and south magnetic poles alternately arranged in a circumferential direction to generate a magnetic force having a predetermined magnitude.

The rotor case 22 includes a hub 26 being press-fitted into a shaft 15 to be connected thereto and a magnet connection part 28 having the annular magnet 25 disposed on an inner circumferential surface thereof. The hub 26 is bent upwardly of the shaft 15 in an axial direction in order to maintain unmating force with the shaft 15, and a disk chucking device 100 according to an exemplary embodiment of the present invention capable of loading the disk is coupled to an outer circumferential surface of the hub 26.

Meanwhile, the stator 40 is constituted of stationary members except for rotating members. The stator 40 includes a base member 60, a sleeve holder 50 having a sleeve 70 press-fitted thereinto to support the sleeve 70, a stator core 42 fixed to the sleeve holder 50, and a winding coil 44 wound around the stator core 42.

The magnet 25 provided on the inner circumferential surface of the magnet connection part 28 is disposed to face the winding coil 44, and electromagnetic interaction between the magnet 25 and the winding coil 44 induces the rotation of the rotor 20. In other words, when the rotor case 22 rotates, the shaft 15 interlocked with the rotor case 22 rotates.

As described above, after the disk is loaded on the disk chucking device 100, the rotor 20 installed on the stator 40 rotates, and thus the disk is rotatably driven. Meanwhile, the disk chucking device 100 having the disk loaded thereon also rotates together with the rotor 20 during the rotation of the rotor 20.

A detailed description of the disk chucking device 100 will be provided below.

Meanwhile, terms used herein associated with directions will now be defined. As viewed in FIG. 1, the axial direction refers to a vertical direction based on the shaft 15, and a radial direction refers to a direction towards an outer edge of the rotor 20 based on the shaft 15 or a central direction of the shaft 15 based on the outer edge of the rotor 20, and the circumferential direction refers to a direction of rotation around the shaft 15.

Hereinafter, a disk chucking device according to an exemplary embodiment of the present invention will be described with reference to the accompanying drawings.

FIG. 2 is a partially enlarged view of a disk chucking device according to an exemplary embodiment of the present invention.

Referring to FIGS. 1 and 2, the disk chucking device 100 according to an exemplary embodiment of the present invention may include a chucking mechanism body 120, a chuck chip 140, and a spring member 160.

The chucking mechanism body 120 is installed on the rotor case 22. That is, the chucking mechanism body 120 is press-fitted into the hub 26 of the rotor case 22 to rotate together with the rotor case 22, as described above.

To this end, the chucking mechanism body 120 includes a boss 122 press-fitted into the hub 26 of the rotor case 22. That is, the hub 26 is press-fitted into an inner portion of the boss 122, such that the chucking mechanism body 120 is installed on the rotor case 22.

Meanwhile, the chucking mechanism body 120 may include an opening 124 allowing the chuck chip 140 to be exposed outwardly. A plurality of openings may be provided in the chucking mechanism body 120.

In addition, the chucking mechanism body 120 may include a chuck chip supporting part 126 disposed under the opening 124 in order to guide the chuck chip 140 thereto by contacting an outer surface of the chuck chip 140 during the movement of the chuck chip 140.

The chuck chip supporting part 126 includes a guiding surface 126a in contact with the chuck chip 140 to allow for the movement of the chuck chip 140, wherein the guiding surface 126a has a shape corresponding to that of a contact surface 142 of the chuck chip 140 to be described below.

Meanwhile, the chucking mechanism body 120 may include a coupling protrusion 128 inserted into an inside of one end of a spring member 160 and preventing the separation of the spring member 160.

The chuck chip 140 is movably installed on the chucking mechanismbody 120 and fixes the disk thereto. That is, the chuck chip 140 elastically supports the disk by the spring member 160 in the radial direction. Accordingly, the chuck chip 140 is slidingly moved to fix the disk.

In addition, the contact surface 142 of the chuck chip 140 formed to be round is disposed to contact the guiding surface 126a of the chuck chip supporting part 126. As such, the contact surface 142 moves while contacting the guiding surface 126a, such that the chuck chip 140 is guided to the chuck chip supporting part 126.

Meanwhile, the chuck chip 140 may include an insertion protrusion 144 formed on a surface thereof, the insertion protrusion 144 being inserted into an inside of the other end of the spring member 160 and preventing the separation of the spring member 160. Accordingly, during the movement of the chuck chip 140, the separation of the spring member 160 from the chuck chip 140 may be prevented.

The spring member 160 is installed such that both ends thereof are supported by the chucking mechanism body 120 and the chuck chip 140, respectively, and includes a permanent deformation suppressing part 162 being formed in a bent portion thereof in order to prevent the permanent deformation of the bent portion at the time of the loading or unloading of the disk and having a smaller pitch than that of other portions.

That is, the spring member 160 may be formed as a coil spring. One end of the spring member 160 is mounted on the coupling protrusion 128 of the chucking mechanism body 120 and the other end thereof is mounted on the insertion protrusion of the chuck chip 140 to provide elastic force.

In this configuration, the spring member 160 is maintained in a somewhat compressed state. That is, when the disk is not loaded thereon, the spring member 160 is somewhat compressed to provide the elastic force to the chuck chip 140.

In addition, the permanent deformation suppressing part 162 is provided in a central portion of the spring member 160, and the permanent deformation suppressing part 162 has a smaller pitch than that of the other portions of the spring member 160.

Accordingly, when the disk is loaded or unloaded, the permanent deformation of the bent portion of the spring member 160 may be prevented.

Meanwhile, the permanent deformation suppressing part 162 may be wound to have turns in the range of 1.5 to 5.

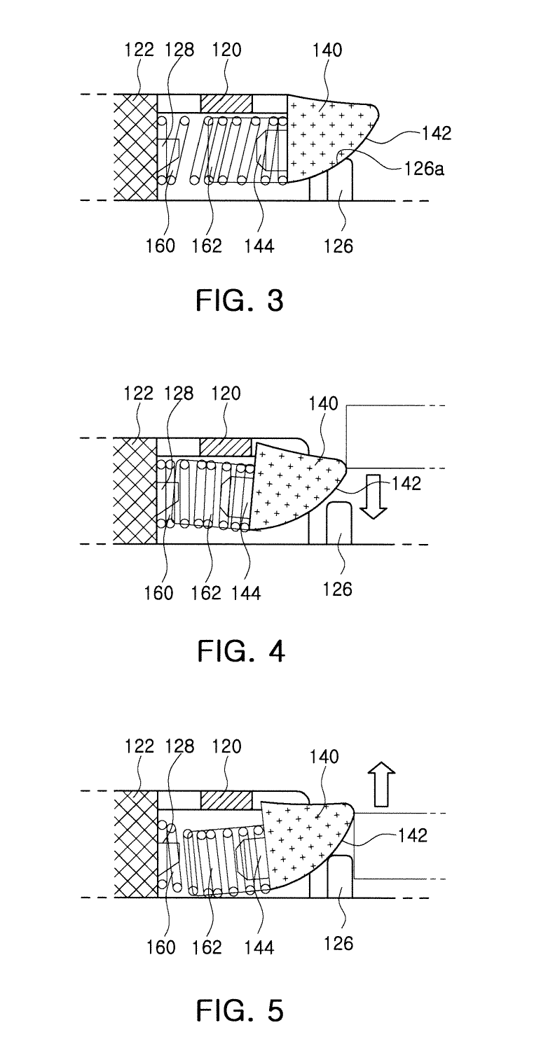

Describing the operation of the spring member 160 in more detail, in a state in which the disk is not loaded or is loaded thereon, the spring member is not bent, while being maintained in a somewhat compressed state, as shown in FIG. 3.

Thereafter, when the disk is loaded thereon, downward load is applied to the chuck chip 140 by the disk, as shown in FIG. 4. In this case, a lower portion of the spring member 160 is bent, while being compressed, and an upper portion thereof is bent, while being extended.

However, the spring member 160 according to the exemplary embodiment of the present invention includes the permanent deformation suppressing part 162 in the bent portion, whereby the bending of the spring member 160 may be alleviated even when the disk is loaded thereon.

Accordingly, even when the disk is loaded thereon, the permanent deformation of the spring member 160 due to the bending thereof may be reduced.

In addition, when the disk is unloaded from the disk chucking device 100, downward load is applied to the chuck chip 140 by the disk, as shown in FIG. 5. In this case, the upper portion of the spring member 160 is bent, while being compressed, and the lower portion thereof is bent, while being extended.

However, the spring member 160 according to the exemplary embodiment of the present invention includes the permanent deformation suppressing part 162 in the bent portion, whereby the bending of the spring member 160 may be alleviated even when the disk is unloaded therefrom.

Accordingly, even when the disk is unloaded therefrom, the permanent deformation of the spring member 160 due to the bending thereof may be reduced.

As set forth above, according to exemplary embodiments of the invention, a spring member includes a permanent deformation suppressing part, such that the permanent deformation thereof may be reduced, whereby vibrations and noise generated during the rotations of the disk may be reduced.

In addition, the permanent deformation of the spring member in a portion thereof in which the spring member is deformed by being bent may be suppressed, whereby the lifespan of the spring member may be increased.

While the present invention has been shown and described in connection with the exemplary embodiments, it will be apparent to those skilled in the art that modifications and variations can be made without departing from the spirit and scope of the invention as defined by the appended claims.

What is claimed is:

1. A disk chucking device comprising:
a chucking mechanism body installed on a rotor case;
a chuck chip movably installed on the chucking mechanism body and fixing a disk thereto; and
a spring member installed such that both ends thereof are supported by the chucking mechanism body and the chuck chip, and including a permanent deformation suppressing part provided in a bent portion thereof in order to prevent permanent deformation of the bent portion when the disk is loaded and unloaded, and having a smaller pitch than that of other portions.

2. The disk chucking device of claim 1, wherein the permanent deformation suppressing part is wound to have turns in a range of 1.5 to 5.

3. The disk chucking device of claim 2, wherein the chucking mechanism body includes an opening allowing the chuck chip to be exposed outwardly.

4. The disk chucking device of claim 3, wherein the chucking mechanism body includes a chuck chip supporting part disposed under the opening in order to guide the chuck chip by contacting an outer surface of the chuck chip during movement of the chuck chip.

5. The disk chucking device of claim 3, wherein a guiding surface of the chuck chip supporting part is in contact with a contact surface of the chuck chip and has a shape corresponding to that of the contact surface of the chuck chip in order to guide the chuck chip.

6. The disk chucking device of claim 3, wherein the chucking mechanism body includes a coupling protrusion inserted into an inside of one end of the spring member and preventing separation of the spring member.

7. The disk chucking device of claim 5, wherein the chuck chip includes an insertion protrusion inserted into an inside of the other end of the spring member and preventing separation of the spring member.
